(19) United States
(12) Patent Application Publication
(10) Pub. No.: US 2020/0003568 A1
(43) Pub. Date: Jan. 2, 2020

(54) APPARATUS AND METHOD FOR INVITATION USING AUTONOMOUS VEHICLE

(71) Applicant: LG ELECTRONICS INC., Seoul (KR)

(72) Inventor: Tae Kyoung KIM, Gyeonggi-do (KR)

(21) Appl. No.: 16/559,131

(22) Filed: Sep. 3, 2019

(30) Foreign Application Priority Data
Jul. 31, 2019 (KR) 10-2019-0093117

(51) Int. Cl. G01C 21/34; B60R 25/24; H04W 4/40; G06Q 10/10; G06Q 50/30

(52) U.S. Cl. CPC G01C 21/3438; B60R 25/24; G06Q 50/30; H04W 4/40; G06Q 10/1095; G01C 21/3415

(57) ABSTRACT

Provided is an invitation device using an autonomous vehicle connected to at least two user terminals and applied to a vehicle management system managing driving of at least two vehicles. The invitation device includes a communicator configured to receive an invitation message and a controller configured to generate an invitation signal. The communicator transmits the invitation signal to at least two user terminals and receives a response signal in response to the invitation signal. The controller determines a first route plan and generates a control signal. The communicator transmits a control signal to at least two vehicles. At least one of an autonomous vehicle, a user terminal, and a server according to an embodiment of the present disclosure may be linked or converged with artificial intelligence modules, drones (Unmanned Aerial Vehicles), robots, Augmented Reality (AR) devices, and devices related to virtual reality (VR) and 5G services.

### CROSS-REFERENCE TO RELATED APPLICATION

This present application claims benefit of priority to Korean Patent Application No. 10-2019-0093117, entitled “APPARATUS AND METHOD FOR INVITATION USING AUTONOMOUS VEHICLE,” filed on Jul. 31, 2019, in the Korean Intellectual Property Office, the entire disclosure of which is incorporated herein by reference.

### BACKGROUND

### 1. Technical Field

The present disclosure relates to an autonomous vehicle reservation system, and in particular, to an invitation device and an invitation method which use an autonomous vehicle for reserving a plurality of autonomous vehicles to invite a plurality of users to a meeting.

### 2. Description of Related Art

As user requirements for vehicles increase, development of the Advanced Driver Assistance System (ADAS) is actively made. Furthermore, development of an autonomous vehicle is being actively carried out.

In relation to an autonomous vehicle, since no human intervention is required to operate the vehicle, when a departure point and a destination point are designated by input, the user or item may be transported according to the specified input.

In one of the conventional methods of transporting a plurality of users using the above-described autonomous vehicle, as disclosed in U.S. Pat. No. 9,733,096, there is a method of determining a plurality of predetermined locations where an autonomous vehicle may pick up or drop off a plurality of users and efficiently transporting a plurality of users by selecting a set of locations that may appropriately replace a location where each user wants to pick up or drop off from a predetermined location.

However, according to the conventional method of transporting the user disclosed in the above-described U.S. Pat. No. 9,733,096, it is possible to only pick up or drop off multiple users at a predetermined location for a single autonomous vehicle, but it is impossible to pick up a plurality of users at a precisely desired location or to drop the picked up users at a precisely desired location by controlling a plurality of autonomous vehicles organically with each other.

For this reason, in order to conduct a group event, for example, a meeting or an appointment, for a plurality of users, there is a problem in that a predetermined group event may be completed only when a user arrives at a predetermined time at one of a plurality of predetermined pickup locations as an alternative location of a pickup location desired by each user.

Therefore, in conducting an event that a plurality of users must gather, for example, a meeting, there is a demand for a technique of allocating an autonomous vehicle to a plurality of users respectively and allowing all the plurality of users to be picked up at desired locations and reach predetermined locations at the same time.

### SUMMARY OF THE INVENTION

An aspect of the present disclosure is to provide a device and a method which are used for inviting a plurality of users by autonomous vehicles according to a way to pick up the plurality of users at desired locations using a plurality of autonomous vehicles, instead of using a single autonomous vehicle to pick up a plurality of users at a predetermined location.

Another aspect of the present disclosure is to provide an invitation device and an invitation method which use an autonomous vehicle that provides convenience of progress of a group event by allowing a plurality of autonomous vehicles to gather a plurality of users at the same time at the same location through one group event designation input.

It will be appreciated by those skilled in the art that aspects to be achieved by the present disclosure are not limited to what has been disclosed hereinabove, and other aspects will be more clearly understood from the following detailed description below.

In order to achieve the above object, an invitation device using an autonomous vehicle according to an embodiment of present disclosure determines a route plan for at least two vehicles and actively adjusts the determined route plan in consideration of driving conditions of all vehicles so that a group event may proceed.

Specifically, according to an embodiment of the present disclosure, an invitation device using an autonomous vehicle, which is connected to at least two user terminals and applied to a vehicle management system managing driving of at least two vehicles, wherein the invitation device includes a communicator configured to receive an invitation message including a same first meeting time applied to each of the at least two vehicles and a controller configured to generate an invitation signal based on the first meeting time. The communicator transmits the invitation signal generated by the controller to each of the at least two user terminals and receives a response signal in response to the invitation signal. The controller determines a first route plan for each of the at least two vehicles based on the response signal and generates a control signal according to the determined first route plan. The communicator transmits a control signal generated by the controller to each of the at least two vehicles. The first route plan is a plan in which the at least two vehicles arrive at a first location at the first meeting time.

According to an embodiment of the present disclosure, the controller may determine whether the first route plan is to be completed successfully, change the first route plan to a second route plan as it is determined that the first route plan is not completed successfully, and generate a control signal according to the changed second route plan. The second route plan may be a plan in which a first user terminal, which transmits the response signal first among the at least two user terminals, designates a second meeting time and a second location, and the remaining vehicles except for a vehicle connected to the first user terminal arrive at the second location at the second meeting time.

According to an embodiment of the present disclosure, the controller may determine whether the first route plan is to be completed successfully, change the first route plan to a third route plan as it is determined that the first route plan is not to be completed successfully, and generate a control signal according to the changed third route plan. The third route plan may be a plan in which the at least two vehicles arrive at a third location at the first meeting time.

According to an embodiment of the present disclosure, the communicator may receive driving situation information based on an uplink grant of a 5G network connected to drive the at least two vehicles in an autonomous driving mode. The controller may update a driving route of the first route plan based on the driving situation information provided from the communicator.

According to an embodiment of the present disclosure, the controller may extract phone number information in the response signal and identify the at least two user terminals based on the extracted phone number information.

According to an embodiment of the present disclosure, the controller may perform authentication by comparing the phone number information with a preset value before starting the vehicle, and permit the vehicle to be started as the authentication is completed.

An embodiment of the present disclosure relates to an invitation method using an autonomous vehicle, which is connected to at least two user terminals and applied to a vehicle management system which manages driving of at least two vehicles, wherein the invitation method includes receiving an invitation message including a same first meeting time applied to each of the at least two vehicles, generating an invitation signal based on the first meeting time, transmitting the invitation signal to each of the at least two user terminals and receiving a response signal in response to the invitation signal, determining a first route plan for each of the at least two vehicles based on the response signal and generating a control signal according to the determined first route plan, and transmitting the generated control signal to each of the at least two vehicles. The first route plan is a plan in which the at least two vehicles arrive at a first location at the first meeting time.

According to an embodiment of the present disclosure, the method may further include determining whether the first route plan is to be completed successfully, changing the first route plan to a second route plan as it is determined that the first route plan is not completed successfully, and generating a control signal according to the changed second route plan. The second route plan may be a plan in which a first user terminal, which transmits the response signal first among the at least two user terminals, designates a second meeting time and a second location, and the remaining vehicles except for a vehicle connected to the first user terminal arrive at the second location at the second meeting time.

According to an embodiment of the present disclosure, the method may further include determining whether the first route plan is to be completed successfully, changing the first route plan to a third route plan as it is determined that the first route plan is not to be completed successfully, and generating a control signal according to the changed third route plan. The third route plan may be a plan in which the at least two vehicles arrive at a third location at the first meeting time.

According to an embodiment of the present disclosure, the method may further include receiving driving situation information based on an uplink grant of a 5G network connected to drive the at least two vehicles in an autonomous driving mode and updating a driving route of the first route plan based on the driving situation information.

According to an embodiment of the present disclosure, the method may further include extracting phone number information in the response signal and identifying the at least two user terminals based on the extracted phone number information.

According to an embodiment of the present disclosure, the method may further include performing authentication by comparing the phone number information with a preset value before starting the vehicle, and permitting the vehicle to be started as the authentication is completed.

An embodiment of the present disclosure relate to a computer-readable recording medium which records an invitation program utilizing an autonomous vehicle, which is applied to a vehicle management system which is connected to at least two user terminals and manages driving of at least two vehicles, wherein the computer-readable recording medium includes a means for receiving an invitation message including a same first meeting time applied to each of the at least two vehicles, a means for generating an invitation signal based on the first meeting time, a means for transmitting the invitation signal to each of the at least two user terminals and receiving a response signal in response to the invitation signal, a means for determining a first route plan for each of the at least two vehicles based on the response signal and generating a control signal according to the determined first route plan, and a means for transmitting the generated control signal to each of the at least two vehicles. The first route plan is a plan in which the at least two vehicles arrive at a first location at the first meeting time.

Details of other embodiments will be included in the detailed description and the drawings.

According to an embodiment of the present disclosure, since a plurality of users may be picked up at a desired location by using a plurality of autonomous vehicles, the plurality of users may conveniently move to a meeting or appointment location.

According to an embodiment of present disclosure, since a plurality of autonomous vehicles, which are respectively boarded by a plurality of users, may be gathered at the same location at the same time through one group event designation input, it is possible to prevent each user from moving to a wrong location.

According to an embodiment of the present disclosure, since an autonomous vehicle is allocated to each of a plurality of users, pickup is performed at an optimal location desired by each user, thereby reducing unnecessary waiting time of the plurality of users.

Embodiments of the present disclosure are not limited to the embodiments described above, and other embodiments not mentioned above will be clearly understood from the description below.

### BRIEF DESCRIPTION OF THE DRAWINGS

FIG. 1 is a diagram illustrating a system to which an invitation device using an autonomous vehicle is applied according to an embodiment of present disclosure.

FIG. 2 is a block diagram illustrating an invitation device using an autonomous vehicle installed at a vehicle side according to an embodiment of present disclosure.

FIG. 3 is a block diagram illustrating an invitation device using an autonomous vehicle installed at a user terminal side according to an embodiment of present disclosure.

FIG. 4 is a block diagram illustrating an invitation device using an autonomous vehicle installed at a server side according to an embodiment of present disclosure.

FIG. 5 is a diagram illustrating an example of basic operations of an autonomous vehicle and a 5G network in a 5G communication system.

FIG. 6 is a diagram illustrating an example of an application operation of an autonomous vehicle and a 5G network in a 5G communication system.

FIGS. 7 to 10 are diagrams illustrating examples of an operation of an autonomous vehicle using 5G communication.

FIGS. 11 and 12 are flowcharts illustrating an invitation method using an autonomous vehicle according to an embodiment of the present disclosure.

FIGS. 13A to 13F are diagrams illustrating an interface of an invitation device using an autonomous vehicle installed on a vehicle side according to an embodiment of present disclosure.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. Suffixes “module” and “unit or portion” for elements used in the following description are merely provided for facilitation of preparing this specification, and thus they are not granted a specific meaning or function. In the following description of the embodiments disclosed herein, the detailed description of related known technology will be omitted when it may obscure the subject matter of the embodiments according to the present disclosure. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like, may be used herein to describe various elements, components, regions, layers, and/or sections, these elements, components, regions, layers, and/or sections should not be limited by these terms. These terms may be only used to distinguish one element, component, region, layer or section from another region, layer or section.

When an element or layer is referred to as being “on,” “engaged to,” “connected to,” or “coupled to” another element or layer, it may be directly on, engaged, connected or coupled to the other element or layer, or intervening elements or layers may be present. The terms “connected” and “coupled” are not restricted to physical or mechanical connections or couplings, and may include electrical connections or couplings, whether direct or indirect.

The connection may be such that the objects are permanently connected or releasably connected.

It must be noted that as used herein and in the appended claims, the singular forms “a,” “an,” and “the” include the plural references unless the context clearly dictates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in this specification refers to a car, an automobile, and the like. Hereinafter, the vehicle will be exemplified as a car.

The vehicle described in the specification may include, but is not limited to, a vehicle having an internal combustion engine as a power source, a hybrid vehicle having an engine and an electric motor as a power source, and an electric vehicle having an electric motor as a power source.

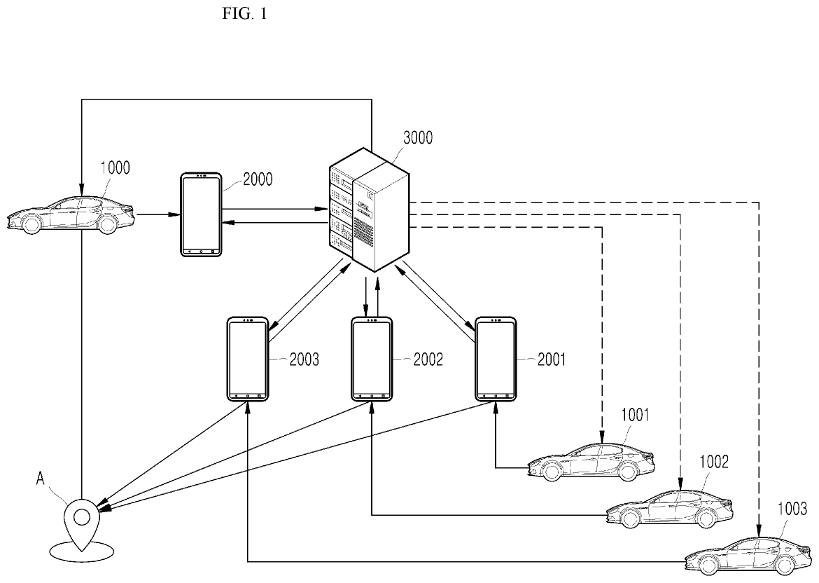

FIG. 1 is a diagram illustrating a system to which an invitation device using an autonomous vehicle is applied according to an embodiment of present disclosure.

Referring to FIG. 1, a host user may input invitation message information including first meeting time information through a user terminal 2000. At this time, the invitation message information may include an appointment location A and a guest list in addition to the first meeting time, that is, an appointment time.

The user terminal 2000 may transmit the received invitation message information to the server 3000. The server 3000 may provide a user interface for inputting invitation message information including a first meeting time through the user terminal 2000.

The server 3000 generates an invitation signal based on the received invitation message information, and transmits the generated invitation signal to user terminals 2001, 2002, and 2003 owned by each of a plurality of guest users.

A plurality of guest users may select approval or rejection after confirming the appointment time, appointment location A, and the like in the invitation message according to the invitation signal through their own user terminals 2001, 2002, and 2003.

The user terminals 2001, 2002, and 2003 generate a response signal by reflecting the selected approval or rejection information, and transmit the generated response signal to the server 3000. At this time, the user terminals 2001, 2002, and 2003 may generate a response signal including the desired vehicle information when the invitation is approved.

If it is determined that the invitation is approved by all of them through the response signal received from the user terminal 2001, 2002, and 2003, the server 3000 matches pickup vehicles 1000, 1001, 1002, 1003 to the respective user terminal 2000, 2001, 2002, and 2003.

The server 3000 establishes a route plan for the driving route so that the pick-up vehicles 1000, 1001, 1002, and 1003 arrive at the appointment location A at the appointment time, and transmits a signal including information of pickup vehicles 1000, 1001, 1002, and 1003 to each of the user terminals 2000, 2001, 2002, and 2003 according to the established route plan.

The server 3000 may generate a control signal for controlling the autonomous vehicle according to the established route plan, and control driving of the vehicles 1000, 1001, 1002, and 1003 according to the generated control signal.

The user terminal 2000, 2001, 2002, 2003 may be a portable device such as a laptop computer, a mobile phone, a personal digital assistant (PDA), a smart phone, and a multimedia device, or a non-portable device such as a personal computer (PC) or a vehicle-mounted device.

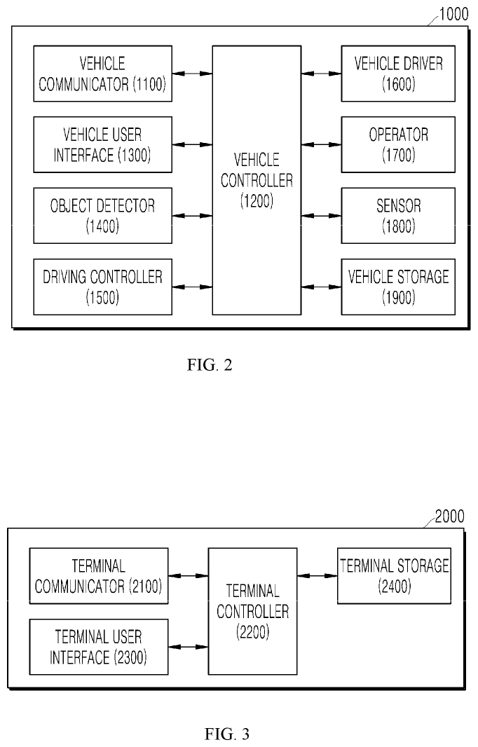

FIG. 2 is a block diagram illustrating an invitation device using an autonomous vehicle installed at a vehicle side according to an embodiment of present disclosure.

Referring to FIG. 2, an invitation device using an autonomous vehicle includes a vehicle communicator 1100, a vehicle controller 1200, a vehicle user interface 1300, an object detector 1400, a driving controller 1500, a vehicle driver 1600, an operator 1700, a sensor 1800, and a vehicle storage 1900.

The vehicle 1000 to which the invitation device using the autonomous vehicle is applied may include other components in addition to the components shown in FIG. 2 and described below, or may not include some of the components shown in FIG. 2 and described below. On the other hand, although it is assumed and shown in FIG. 2 that the invitation device using the autonomous vehicle is mounted on the vehicle 1000, the same device may be applied to other vehicles 1001, 1002, and 1003.

The vehicles 1000, 1001, 1002, and 1003 may be switched from the autonomous driving mode to the manual mode or from the manual mode to the autonomous driving mode according to driving conditions. Here, the driving situation may be determined by at least one of information received by the vehicle communicator 1100, external object information detected by the object detector 1400, and navigation information obtained by the navigation module.

The vehicles 1000, 1001, 1002, and 1003 may be switched from the autonomous driving mode to the manual mode or from the manual mode to the autonomous driving mode according to a user input received through the vehicle user interface 1300.

When the vehicles 1000, 1001, 1002, and 1003 are driven in the autonomous driving mode, the vehicles 1000, 1001, 1002, and 1003 may be driven under the control of the operator 1700 which controls driving, leaving, and parking operations. On the other hand, when the vehicles 1000, 1001, 1002, and 1003 are driven in the manual mode, the vehicles 1000, 1001, 1002, and 1003 may be driven by an input through a mechanical driving operation of the driver.

The vehicle communicator 1100 may be a module for performing communication with an external device. Here, the external device may be user terminals 2000, 2001, 2002, and 2003, another vehicle, or a server 3000.

The vehicle communicator 1100 may receive a control signal according to the first route plan, the second route plan, or the third route plan based on the downlink grant of the 5G network from the server 3000.

The vehicle communicator 1100 may include at least one among a transmission antenna, a reception antenna, a radio frequency (RF) circuit capable of implementing various communication protocols, and an RF element in order to perform communication.

The vehicle communicator 1100 may perform short range communication, GPS signal reception, V2X communication, optical communication, broadcast transmission and reception, and intelligent transport systems (ITS) communication.

According to an embodiment, the vehicle communicator 1100 may further support other functions in addition to the described functions, or may not support some of the described functions.

The vehicle communicator 1100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle communicator 1100 may form short-range wireless communication networks so as to perform short-range communication between the vehicles 1000, 1001, 1002, 1003 and at least one external device.

The vehicle communication unit 1100 may include a Global Positioning System (GPS) module or a Differential Global Positioning System (DGPS) module for obtaining location information of the vehicle 1000, 1001, 1002, 1003.

The vehicle communicator 1100 may include a module for supporting wireless communication between the vehicles 1000, 1001, 1002, 1003 and a server (V2I: vehicle to infrastructure), communication with another vehicle (V2V: vehicle to vehicle) or communication with a pedestrian (V2P: vehicle to pedestrian). That is, the vehicle communicator 1100 may include a V2X communication module. The V2X communication module may include an RF circuit capable of implementing V2I, V2V, and V2P communication protocols.

The vehicle communicator 1100 may receive a hazard information broadcast signal transmitted by another vehicle through the V2X communication module, and may transmit a hazard information query signal and receive a hazard information response signal in response thereto.

The vehicle communicator 1100 may include an optical communication module for performing communication with an external device via light. The optical communication module may include both a light transmitting module for converting electrical signals into optical signals and transmitting the optical signals to the outside, and a light receiving module for converting the received optical signals into electrical signals.

According to an embodiment, the light transmitting module may be integrally formed with a lamp included in the vehicles 1000, 1001, 1002, 1003.

The vehicle communicator 1100 may include a broadcast communication module for receiving broadcast signals from an external broadcast management server, or transmitting broadcast signals to the broadcast management server through broadcast channels. Examples of the broadcast channels may include a satellite channel and a terrestrial channel. Example of the broadcast signal may include a TV broadcast signal, a radio broadcast signal, and a data broadcast signal.

The vehicle communicator 1100 may include an ITS communication module that exchanges information, data or signals with a traffic system. The ITS communication module may provide the obtained information and data to the traffic system. The ITS communication module may receive information, data, or signals from the traffic system. For example, the ITS communication module may receive road traffic information from the communication system and provide the road traffic information to the vehicle controller 1200. For example, the ITS communication module may receive control signals from the traffic system and provide the control signals to the vehicle controller 1200 or a processor provided in the vehicles 1000, 1001, 1002, 1003.

Depending on the embodiment, the overall operation of each module of the vehicle communicator 1100 may be controlled by a separate process provided in the vehicle communicator 1100. The vehicle communicator 1100 may include a plurality of processors, or may not include a processor. When a processor is not included in the vehicle communicator 1100, the vehicle communicator 1100 may be operated by either a processor of another apparatus in the vehicles 1000, 1001, 1002, 1003 or the vehicle controller 1200.

The vehicle communicator 1100 may, together with the vehicle user interface 1300, implement a vehicle-use display device. In this case, the vehicle-use display device may be referred to as a telematics device or an audio video navigation (AVN) device.

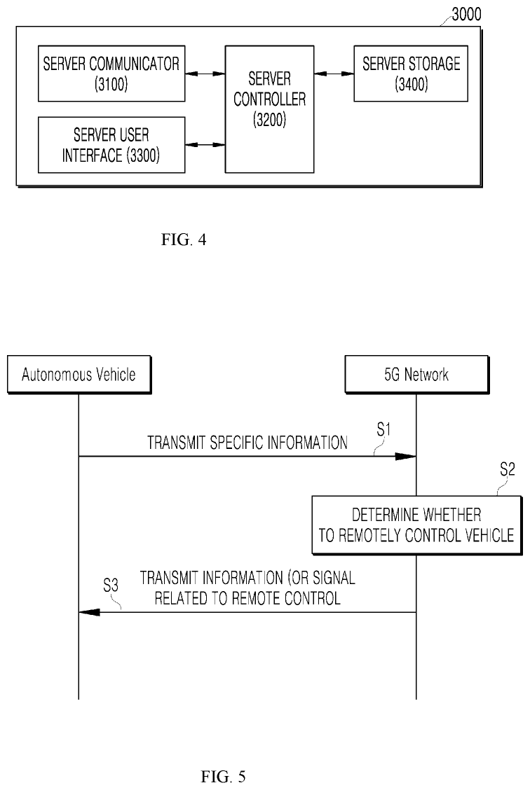

FIG. 5 is a diagram illustrating an example of basic operations of an autonomous vehicle and a 5G network in a 5G communication system.

The vehicle communicator 1100 may transmit specific information over a 5G network when the vehicles 1000, 1001, 1002, 1003 is operated in the autonomous driving mode.

The specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 1300 and a safety rating of the vehicle.

In addition, the 5G network may determine whether a vehicle is to be remotely controlled (S2).

The 5G network may include a server or a module for performing remote control related to autonomous driving.

The 5G network may transmit information (or a signal) related to the remote control to an autonomous driving vehicle (S3).

As described above, information related to the remote control may be a signal directly applied to the autonomous driving vehicle, and may further include service information necessary for autonomous driving. The autonomous driving vehicle according to this embodiment may receive service information such as insurance for each interval selected on a driving route and risk interval information, through a server connected to the 5G network to provide services related to the autonomous driving.

An essential process for performing 5G communication between the autonomous driving vehicles 1000, 1001, 1002, 1003 and the 5G network (for example, an initial access process between the vehicles 1000, 1001, 1002, 1003 and the 5G network) will be briefly described below.

An example of application operations through the autonomous driving vehicles 1000, 1001, 1002, 1003 performed in the 5G communication system and the 5G network is as follows.

The vehicles 1000, 1001, 1002, 1003 may perform an initial access process with the 5G network (initial access step, S20). The initial access process may include a cell search process for downlink (DL) synchronization acquisition and a process for obtaining system information.

The vehicles 1000, 1001, 1002, 1003 may perform a random access process with the 5G network (random access step, S21). The random access process may include a process for uplink (UL) synchronization acquisition or a preamble transmission process for UL data transmission, or a random access response receiving process.

The 5G network may transmit an Uplink (UL) grant for scheduling transmission of specific information to the autonomous driving vehicles 1000, 1001, 1002, 1003 (UL grant receiving step, S22).

The process in which the vehicles 1000, 1001, 1002, 1003 receives the UL grant may include a scheduling process for receiving a time/frequency source for the transmission of the UL data over the 5G network.

The autonomous driving vehicles 1000, 1001, 1002, 1003 may transmit specific information over the 5G network based on the UL grant (specific information transmission step, S23).

The 5G network may determine whether the vehicles 1000, 1001, 1002, 1003 is to be remotely controlled based on the specific information transmitted from the vehicle 1000 (vehicle remote control determination step, S24).

The autonomous driving vehicles 1000, 1001, 1002, 1003 may receive the DL grant through a physical DL control channel for receiving a response on pre-transmitted specific information from the 5G network (DL grant receiving step, S25).

The 5G network may transmit information (or a signal) related to the remote control to the autonomous driving vehicles 1000, 1001, 1002, 1003 based on the DL grant (remote control related information transmission step, S26).

A process in which the initial access process and/or the random access process between the 5G network and the autonomous driving vehicles 1000, 1001, 1002, 1003 is combined with the DL grant receiving process has been exemplified. However, the present disclosure is not limited thereto.

For example, the initial access process and/or the random access process may be performed through the initial access step, the UL grant receiving step, the specific information transmission step, the vehicle remote control determination step, and the remote control related information transmission step. In addition, for example, the initial access process and/or the random access process may be performed through the random access step, the UL grant receiving step, the specific information transmission step, the vehicle remote control determination step, and the remote control related information transmission step. The autonomous driving vehicles 1000, 1001, 1002, 1003 may be controlled by the combination of an AI operation and the DL grant receiving process through the specific information transmission step, the vehicle remote control determination step, the DL grant receiving step, and the remote control related information transmission step.

The operation of the autonomous driving vehicles 1000, 1001, 1002, 1003 described above is merely exemplary, but the present disclosure is not limited thereto.

For example, the operation of the autonomous driving vehicle 1000, 1001, 1002, 1003 may be performed by selectively combining the initial access step, the random access step, the UL grant receiving step, or the DL grant receiving step with the specific information transmission step, or the remote control related information transmission step. The operation of the autonomous driving vehicle 1000, 1001, 1002, 1003 may include the random access step, the UL grant receiving step, the specific information transmission step, and the remote control related information transmission step. The operation of the autonomous driving vehicle 1000, 1001, 1002, 1003 may include the initial access step, the random access step, the specific information transmission step, and the remote control related information transmission step. The operation of the autonomous driving vehicle 1000, 1001, 1002, 1003 may include the UL grant receiving step, the specific information transmission step, the DL grant receiving step, and the remote control related information transmission step.

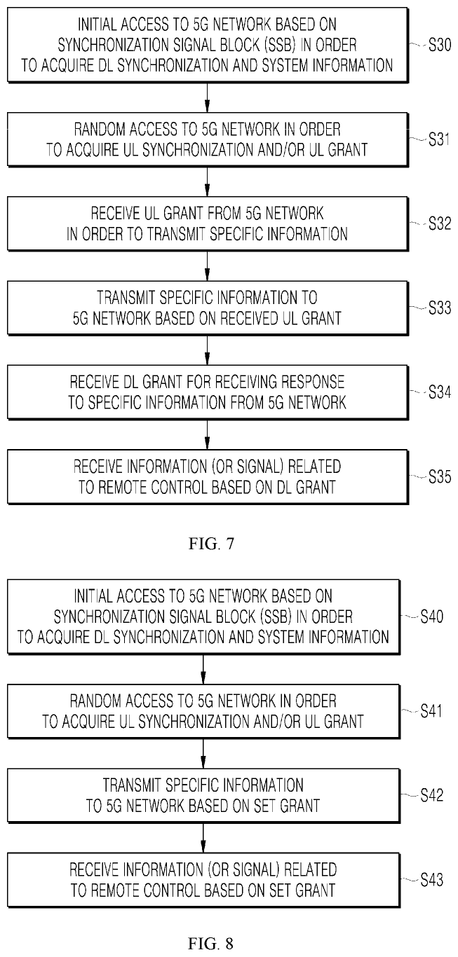

As illustrated in FIG. 7, the vehicle 1000, 1001, 1002, 1003 including an autonomous driving module may perform an initial access process with the 5G network based on Synchronization Signal Block (SSB) in order to acquire DL synchronization and system information (initial access step).

The autonomous driving vehicle 1000, 1001, 1002, 1003 may perform a random access process with the 5G network for UL synchronization acquisition and/or UL transmission (random access step, S31).

The autonomous driving vehicle 1000, 1001, 1002, 1003 may receive the UL grant from the 5G network for transmitting specific information (UL grant receiving step, S32).

In addition, the autonomous driving available vehicles 1000, 1001, 1002, and 1003 transmit specific information to the 5G network based on the UL grant (specific information transmission step, S33).

The autonomous driving vehicle 1000, 1001, 1002, 1003 may receive the DL grant from the 5G network for receiving a response to the specific information (DL grant receiving step, S34).

The autonomous driving vehicle 1000, 1001, 1002, 1003 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. In addition, QCL relation may be added with respect to the beam reception direction of the PDCCH including the DL grant in the DL grant receiving step.

As illustrated in FIG. 8, the autonomous driving vehicle 1000, 1001, 1002, 1003 may perform an initial access process with the 5G network based on SSB for acquiring DL synchronization and system information (initial access step, S40).

The autonomous driving vehicle 1000, 1001, 1002, 1003 may perform a random access process with the 5G network for UL synchronization acquisition and/or UL transmission (random access step, S41).

The autonomous driving vehicle 1000, 1001, 1002, 1003 may transmit specific information based on a configured grant to the 5G network (UL grant receiving step, S42). In other words, the autonomous driving vehicle 1000, 1001, 1002, 1003 may receive the configured grant instead of receiving the UL grant from the 5G network.

The autonomous driving vehicle 1000, 1001, 1002, 1003 may receive the remote control related information (or a signal) from the 5G network based on the configured grant (remote control related information receiving step, S43).

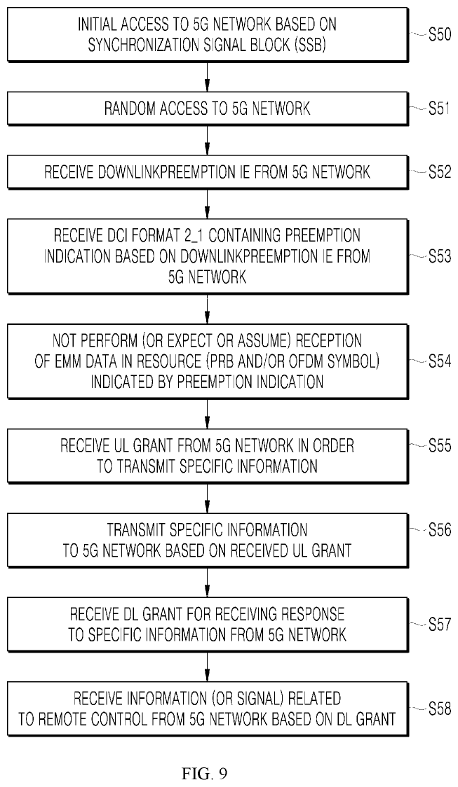

As illustrated in FIG. 9, the autonomous driving vehicle 1000, 1001, 1002, 1003 may perform an initial access process with the 5G network based on the SSB for acquiring the DL synchronization and the system information (initial access step, S50).

The autonomous driving vehicle 1000, 1001, 1002, 1003 may perform a random access process with the 5G network for UL synchronization acquisition and/or UL transmission (random access step, S51).

In addition, the autonomous driving vehicle 1000, 1001, 1002, 1003 may receive Downlink Preemption (DL) and Information Element (IE) from the 5G network (DL Preemption IE reception step, S52).

The autonomous driving vehicle 1000, 1001, 1002, 1003 may receive DCI (Downlink Control Information) format 2_1 including preemption indication based on the DL preemption IE from the 5G network (DCI format 2_1 receiving step, S53).

The autonomous driving vehicle 1000, 1001, 1002, 1003 may not perform (or expect or assume) the reception of eMBB data in the resource (PRB and/or OFDM symbol) indicated by the pre-emption indication (step of not receiving eMBB data, S54).

The autonomous driving vehicle 1000, 1001, 1002, 1003 may receive the UL grant over the 5G network for transmitting specific information (UL grant receiving step, S55).

The autonomous driving vehicle 1000, 1001, 1002, 1003 may transmit the specific information to the 5G network based on the UL grant (specific information transmission step, S56).

The autonomous driving vehicle 1000, 1001, 1002, 1003 may receive the DL grant from the 5G network for receiving a response to the specific information (DL grant receiving step, S57).

The autonomous driving vehicle 1000, 1001, 1002, 1003 may receive the remote control related information (or signal) from the 5G network based on the DL grant (remote control related information receiving step, S58).

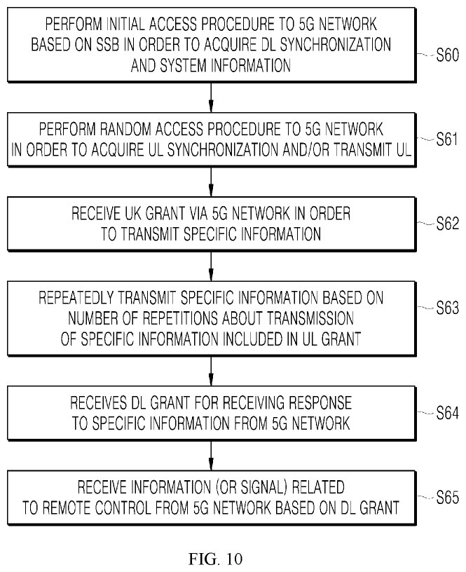

As illustrated in FIG. 10, the autonomous driving vehicle 1000, 1001, 1002, 1003 may perform an initial access process with the 5G network based on SSB for acquiring DL synchronization and system information (initial access step, S60).

The autonomous driving vehicle 1000, 1001, 1002, 1003 may perform a random access process with the 5G network for UL synchronization acquisition and/or UL transmission (random access step, S61).

The autonomous driving vehicle 1000, 1001, 1002, 1003 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous driving vehicle 1000, 1001, 1002, 1003 may transmit the specific information to the 5G network based on the UL grant.

The repeated transmission of the specific information may be performed by frequency hopping, and the first transmission of the specific information may be performed from a first frequency source, and the second transmission of the specific information may be performed from a second frequency source.

The specific information may be transmitted through Narrowband of Resource Block (6RB) and Resource Block (1RB).

The autonomous driving vehicle 1000, 1001, 1002, 1003 may receive the DL grant from the 5G network for receiving a response to the specific information (DL grant receiving step, S64).

The autonomous driving vehicle 1000, 1001, 1002, 1003 may receive the remote control related information (or signal) from the 5G network based on the DL grant (remote control related information receiving step, S65).

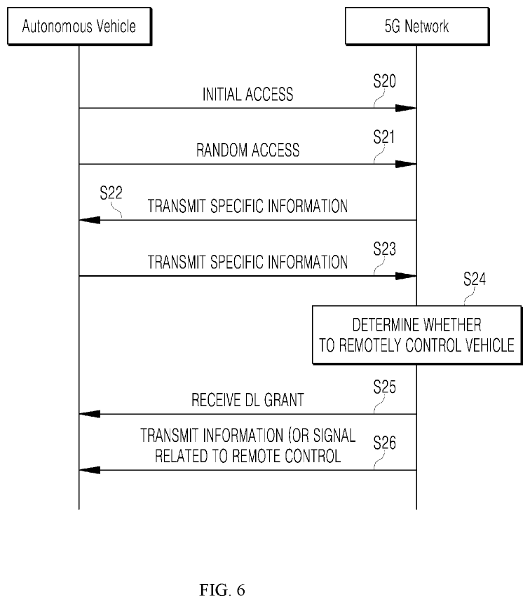

The above-described 5G communication technique may be applied in combination with the embodiment proposed in this specification, which will be described in FIG. 1 to FIG. 13f, or supplemented to specify or clarify the technical feature of the embodiment proposed in this specification.

The vehicle 1000, 1001, 1002, 1003 may be connected to an external server through a communication network, and may be capable of moving along a predetermined route without a driver's intervention by using an autonomous driving technique.

In the embodiment described below, a user may be interpreted as a driver, a passenger, or an owner of a user terminal.

While the vehicle 1000, 1001, 1002, 1003 is driving in the autonomous driving mode, the type and frequency of accident occurrence may depend on the capability of the vehicle 1000 of sensing dangerous elements in the vicinity in real time. The route to the destination may include intervals with different levels of risk based on various causes, such as weather, terrain characteristic, and traffic congestion.

At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 1000, 1001, 1002, 1003 may operate in association with at least one artificial intelligence module or robot included in the vehicle 1000, 1001, 1002, 1003 in the autonomous driving mode.

For example, the vehicle 1000, 1001, 1002, 1003 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 1000, 1001, 1002, 1003 to a final destination. For example, the robot may perform a function of providing route guidance to a final destination to a user who alights from the vehicle 1000, 1001, 1002, 1003. For example, the robot may perform a function of transporting the user who alights from the vehicle 1000, 1001, 1002, 1003 to the final destination

At least one electronic apparatus included in the vehicle 1000, 1001, 1002, 1003 may communicate with the robot through a communication device.

At least one electronic apparatus included in the vehicle 1000 may provide, to the robot, data processed by the at least one electronic apparatus included in the vehicle 1000, 1001, 1002, 1003. For example, at least one electronic apparatus included in the vehicle 1000, 1001, 1002, 1003 may provide, to the robot, at least one among object data indicating an object near the vehicle, HD map data, vehicle status data, vehicle position data, and driving plan data.

At least one electronic apparatus included in the vehicle 1000, 1001, 1002, 1003 may receive, from the robot, data processed by the robot. At least one electronic apparatus included in the vehicle 1000, 1001, 1002, 1003 may receive at least one among sensing data sensed by the robot, object data, robot status data, robot location data, and robot movement plan data.

At least one electronic apparatus included in the vehicle 1000, 1001, 1002, 1003 may generate a control signal based on data received from the robot. For example, at least one electronic apparatus included in the vehicle may compare information on the object generated by an object detection device with information on the object generated by the robot, and generate a control signal based on the comparison result. At least one electronic apparatus included in the vehicle 1000, 1001, 1002, 1003 may generate a control signal so that interference between the vehicle movement route and the robot movement route may not occur.

At least one electronic apparatus included in the vehicle 1000, 1001, 1002, 1003 may include a software module or a hardware module for implementing an artificial intelligence (AI) (hereinafter referred to as an artificial intelligence module). At least one electronic apparatus included in the vehicle 1000 may input obtained data into the artificial intelligence module, and use data outputted from the artificial intelligence module.

The artificial intelligence module may perform machine learning of input data by using at least one artificial neural network (ANN). The artificial intelligence module may output driving plan data through machine learning of input data.

At least one electronic apparatus included in the vehicle 1000, 1001, 1002, 1003 may generate a control signal based on the data outputted from the artificial intelligence module.

According to the embodiment, at least one electronic apparatus included in the vehicle 1000, 1001, 1002, 1003 may receive data processed by an artificial intelligence from an external device through a communication device. At least one electronic apparatus included in the vehicle may generate a control signal based on the data processed by the artificial intelligence.

The vehicle controller 1200 may receive a control signal of the server 3000 through the vehicle communicator 1100 and control driving of an autonomous driving mode according to the control signal.

The vehicle controller 1200 may control the vehicles 1000, 1001, 1002, and 1003 to move to the positions of the user terminals 2000, 2001, 2002, and 2003 based on the control signal of the server 3000.

The vehicle controller 1200 may move the each of the vehicles 1000, 1001, 1002, and 1003 to allows participants having the respective user terminal 2000, 2001, 2002, and 2003 to board the respective vehicles 1000, 1001, 1002, and 1003 at a predetermined precise time by using the time-specific prediction position information of each of the user terminals 2000, 2001, 2002, and 2003 included in the control signal of the server 3000.

When the participant having each of the user terminal 2000, 2001, 2002, and 2003 is detected in the vehicle through the vehicle user interface 1300, the vehicle controller 1200 may control the operator 1700 to move the vehicle to the appointment location.

The vehicle controller 1200 may be implemented using at least one among application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electronic units for performing other functions.

The vehicle user interface 1300 is for communication between the vehicles 1000, 1001, 1002, and 1003 and the vehicle users, and may receive an input signal from the user, transmit the received input signal to the vehicle controller 1200, and provide the user with information held by the vehicles 1000, 1001, 1002, and 1003 under the control of the vehicle controller 1200. The vehicle user interface 1300 may include an input module, an internal camera, a biometric sensing module, and an output module but is not limited thereto.

The input module is for receiving information from a user, and the data collected by the input module may be analyzed by the vehicle controller 1200 and processed by a user's control command.

The input module may receive a destination of the vehicles 1000, 1001, 1002, 1003 from a user and provide the destination to the vehicle controller 1200.

The input module may input a signal, which designates and deactivates at least one sensor module among the plurality of sensor modules of the object detector 1400, to the vehicle controller 1200 according to a user input.

The input module may be disposed inside the vehicle. For example, the input module may disposed in one area of a steering wheel, one area of an instrument panel, one area of a seat, one area of each pillar, one area of a door, one area of the center console, one area of the head lining, one area of the sun visor, one area of the windshield, one area of the window or etc.

The output module is for generating output related to visual, auditory or tactile. The output module may output a sound or an image.

The output module may include at least one of a display module, a sound output module, and a haptic output module.

The display module may receive the 3D around view image from the image processor 1200 and output it as a form of a screen image that may be recognized by the user.

The display module may display graphic objects corresponding to various pieces of information.

The display modules may include at least one of Liquid Crystal Display (LCD), Thin Film Transistor Liquid Crystal Display (TFT LCD), Organic Light-Emitting Diode (OLED), Flexible Display, 3D display, and e-ink display.

The display module forms a mutual layer structure or is integrally formed with the touch input module to implement a touch screen.

The display module may be implemented as a Head Up Display (HUD). When the display module is implemented as a HUD, the display module may include a projection module to output information through an image projected on a window or a windshield.

The display module may include a transparent display. The transparent display may be attached to a window shield or a window.

The transparent display may display a predetermined screen with a predetermined transparency. In order to have transparency, the transparent display may include at least one of a transparent thin film elecroluminescent (TFEL), a transparent organic light-emitting diode (OLED), a transparent liquid crystal display (LCD), a transmissive transparent display, and a transparent light emitting diode (LED) display. The transparency of the transparent display may be adjusted.

The vehicle user interface 1300 may include a plurality of display modules.

The display module may be disposed in one area of the steering wheel, one area of the instrument panel, one area of the seat, one area of each pillar, one area of the door, one area of the center console, one area of the headlining, and one of the sun visor or may be implemented in one area of the wind shield and one area of the window.

The sound output module may convert an electrical signal provided from the vehicle controller 1200 into an audio signal and output the audio signal. For this, the sound output module may include one or more speakers.

The haptic output module may generate a tactile output. For example, the haptic output module may operate to vibrate a steering wheel, a seatbelt, and a seat so that the user may recognize an output.

The object detector 1400 is for detecting an object located outside the vehicles 1000, 1001, 1002, and 1003, and may generate object information based on the sensing data and transmit the generated object information to the vehicle controller 1200. At this time, the object may include a variety of objects related to driving of the vehicles 1000, 1001, 1002, and 1003, for example, lanes, other vehicles, pedestrians, motorcycles, traffic signals, lights, roads, structures, speed bumps, terrain, animals, and the like.

The object detector 1400 is a plurality of sensor modules, and may include camera modules 1410a, 1410b, 1410c, and 1410d as a plurality of imaging units, Light Imaging Detection and Ranging (LIDAR), ultrasonic sensors, Radio Detection and Ranging (RADAR) 1450, and infrared sensors.

The object detector 1400 may sense environment information around the vehicles 1000, 1001, 1002, and 1003 through the plurality of sensor modules.

According to an embodiment, the object detector 1400 may further include other components in addition to the described components, or may not include some of the described components.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be disposed at an appropriate position outside the vehicle for sensing an object disposed at the front, back, or side of the vehicle.

The lidar may include a laser transmitting module, and a laser receiving module. The lidar may be embodied using the time of flight (TOF) method or in the phase-shift method.

The lidar may be implemented using a driving method or a non-driving method.

When implemented with a driving method, the lidar is rotated by a motor and may detect objects around the vehicles 1000, 1001, 1002, and 1003, and when implemented with a non-driving method, the lidar may detect an object located within a predetermined range with respect to the vehicles 1000, 1001, 1002, and 1003 by optical steering. The vehicles 1000, 1001, 1002, and 1003 may include a plurality of non-driven lidars.

The lidar may detect an object using the time of flight (TOF) method or the phase-shift method using laser light as a medium, and detect the location of the detected object, the distance from the detected object and the relative speed of the detected object.

The lidar may be disposed at an appropriate position outside the vehicle for sensing an object disposed at the front, back, or side of the vehicle.

The imaging unit may be located at a suitable location outside of the vehicle, for example, the front part, rear part, right side mirrors and left side mirrors of the vehicle to obtain an image outside the vehicle. The imaging unit may be a mono camera, but is not limited thereto, and may be a stereo camera, an around view monitoring (AVM) camera, or a 360 degree camera.

The imaging unit may be disposed close to the front windshield, in the inside of the vehicle, to obtain an image of the front of the vehicle. Alternatively, the imaging unit may be disposed around the front bumper or radiator grille.

The imaging unit may be disposed close to the rear glass, in the inside of the vehicle, to obtain an image of the rear of the vehicle. Alternatively, the imaging unit may be disposed around the rear bumper, trunk or tail gate.

The imaging unit may be disposed close to at least one of the side windows in the inside of the vehicle to obtain an image of the vehicle side. In addition, the imaging unit may be disposed around the fender or door.

The imaging unit may provide the acquired image to the depth estimator 1210 of the vehicle controller 1200.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be disposed at an appropriate position outside the vehicle for sensing an object at the front, back, or side of the vehicle.

The vehicle controller 1200 may control the overall operation of each module of the object detector 1400.

The vehicle controller 1200 may compare data sensed by the radar, the lidar, the ultrasonic sensor, and the infrared sensor with pre-stored data so as to detect or classify an object.

The vehicle controller 1200 may detect and track the object based on the obtained image. The vehicle controller 1200 may perform operations such as calculating a distance to an object and calculating a relative speed with the object through an image processing algorithm.

For example, the vehicle controller 1200 may obtain distance information and relative speed information with respect to the object from the acquired image based on the change in the object size over time.

For example, the vehicle controller 1200 may obtain the distance information from the object and the relative speed information of the object through, for example, a pin hole model and road surface profiling.

The vehicle controller 1200 may detect an object and perform tracking of the object based on the reflected electromagnetic wave reflected back from the object. The vehicle controller 1200 may perform operations such as calculation of the distance to the object and calculation of the relative speed of the object based on the electromagnetic waves.

The vehicle controller 1200 may detect an object, and perform tracking of the object based on the reflected laser light reflected back from the object. Based on the laser light, the vehicle controller 1200 may perform operations such as calculation of the distance to the object and calculation of the relative speed of the object based on the laser light.

The vehicle controller 1200 may detect an object and perform tracking of the object based on the reflected ultrasonic wave reflected back from the object. The vehicle controller 1200 may perform operations such as calculation of the distance to the object and calculation of the relative speed of the object based on the reflected ultrasonic wave.

The vehicle controller 1200 may detect an object and perform tracking of the object based on the reflected infrared light reflected back from the object. The vehicle controller 1200 may perform operations such as calculation of the distance to the object and calculation of the relative speed of the object based on the infrared light.

According to an embodiment, the object detector 1400 may include a processor separate from the vehicle controller 1200. In addition, the radar, the lidar, the ultrasonic sensor, and the infrared sensor may each include a processor.

When the processor is included in the object detector 1400, the object detector 1400 may be operated according to the control of the processor under the control of the vehicle controller 1200.

The driving controller 1500 may receive a user input for driving. In the manual mode, the vehicles 1000, 1001, 1002, and 1003 may be driven based on a signal provided by the driving controller 1500.

The vehicle driver 1600 may electrically control driving of various devices in the vehicles 1000, 1001, 1002, and 1003. The vehicle driver 1600 may electrically control driving of power trains, chassis, doors/windows, safety devices, lamps, and air conditioners in the vehicles 1000, 1001, 1002, and 1003.

The operator 1700 may control various driving of the vehicles 1000, 1001, 1002, and 1003. The operator 1700 may be operated in an autonomous driving mode.

The operator 1700 may include a driving module, a departure module, and a parking module.

According to an embodiment, the operator 1700 may further include other components in addition to the described components, or may not include some of the described components.

The operator 1700 may include a processor under the control of the vehicle controller 1200. Each module of the operator 1700 may include a processor individually.

Depending on the embodiment, when the operator 1700 is implemented as software, it may be a sub-concept of the vehicle controller 1200.

The driving module may perform driving of the vehicles 1000, 1001, 1002, and 1003.

The driving module may receive the object information from the object detector 1400, provide a control signal to the vehicle driving module, and perform driving of the vehicles 1000, 1001, 1002, and 1003.

The driving module may receive a signal from an external device through the vehicle communicator 1100, provide a control signal to the vehicle driving module, and perform driving of the vehicles 1000, 1001, 1002, and 1003.

The departure module may perform departure of the vehicles 1000, 1001, 1002, and 1003.

The departure module may receive navigation information from the navigation module, provide a control signal to the vehicle driving module, and perform the departure of the vehicles 1000, 1001, 1002, and 1003.

The departure module may receive the object information from the object detector 1400, provide a control signal to the vehicle driving module, and perform departure of the vehicles 1000, 1001, 1002, and 1003.

The departure module may receive a signal from an external device through the vehicle communicator 1100, provide a control signal to the vehicle driving module, and perform departure of the vehicles 1000, 1001, 1002, and 1003.

The parking module may perform parking of the vehicles 1000, 1001, 1002, and 1003.

The parking module may receive navigation information from the navigation module, provide a control signal to the vehicle driving module, and perform parking of the vehicles 1000, 1001, 1002, and 1003.

The parking module may receive the object information from the object detector 1400, provide a control signal to the vehicle driving module, and perform parking of the vehicles 1000, 1001, 1002, and 1003.

The parking module may receive a signal from an external device through the vehicle communicator 1100, provide a control signal to the vehicle driving module, and perform parking of the vehicle 1000, 1001, 1002, and 1003.

The navigation module may provide navigation information to the vehicle controller 1200. The navigation information may include at least one among map information, set destination information, route information according to destination setting, information on various objects on the route, lane information, and present location information of the vehicle.

The navigation module may provide the vehicle controller 1200 with a parking map of the parking lot into which the vehicles 1000, 1001, 1002, 1003 enter. If the vehicles 1000, 1001, 1002, and 1003 enter the parking lot, the vehicle controller 1200 may receive a parking lot map from the navigation module and generate map data by projecting a calculated traveling route and fixed identification information onto the provided parking lot map.

The navigation module may include a memory. The memory may store navigation information. The navigation information may be updated by information received through the vehicle communicator 1100. The navigation module may be controlled by an embedded processor or may operate by receiving an external signal, for example, a control signal from the vehicle controller 1200, but is not limited thereto.

The driving module of the operator 1700 may receive navigation information from the navigation module, provide a control signal to the vehicle driving module, and perform driving of the vehicles 1000, 1001, 1002, and 1003.

The sensor 1800 may sense a state of the vehicles 1000, 1001, 1002, and 1003 using sensors mounted on the vehicles 1000, 1001, 1002, and 1003, that is, detect signals regarding the vehicles 1000, 1001, 1002, and 1003, and obtain traveling route information of the vehicles 1000, 1001, 1002, and 1003 according to the detected signal. The sensor 1800 may provide the obtained movement route information to the vehicle controller 1200.

The sensor 1800 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 1800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 1800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), but is not limited thereto.

The sensor 1800 may generate vehicle status information based on sensing data. The vehicle status information may be information generated based on data sensed by various sensors included in the inside of the vehicle.

The vehicle status information may include at least one among posture information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, vehicle interior temperature information, vehicle interior humidity information, pedal position information, and vehicle engine temperature information.

The vehicle storage 1900 may be electrically connected to the vehicle controller 1200. The vehicle storage 1900 may store basic data for each part of the invitation device using the autonomous vehicle, control data for controlling the operation of each part of the invitation device using the autonomous vehicle, and inputted/outputted data. The vehicle storage 1900 may be various storage devices such as a ROM, a RAM, an EPROM, a flash drive, and a hard drive, in terms of hardware. The vehicle storage 1900 may store a program for the processing or controlling of the vehicle controller 1200 and various data for the entire operation of the vehicles 1000, 1001, 1002, and 1003, in particular, driver tendency information. The vehicle storage 1900 may be integrally formed with the vehicle controller 1200, or implemented as a sub-component of the vehicle controller 1200.

FIG. 3 is a block diagram illustrating an invitation device using an autonomous vehicle installed at a user terminal side according to an embodiment of present disclosure.

Referring to FIG. 3, an invitation device using an autonomous vehicle may include a terminal communicator 2100, a terminal controller 2200, a terminal user interface 2300, and a terminal storage 2400.

The user terminal 2000 to which the invitation device using the autonomous vehicle is applied may include other components in addition to the components shown in FIG. 3 and described below, or may not include some of the components shown in FIG. 3 and described below. On the other hand, although it is assumed and shown in FIG. 3 that the invitation device using the autonomous vehicle is mounted on the user terminal 2000, the same device may be applied to other user terminals 2001, 2002, and 2003.

The terminal communicator 2100 may transmit invitation message information for setting an appointment time, an appointment location, or a guest list to the server 3000.

The terminal communicator 2100 may receive an invitation signal from the server 3000 and provide the received invitation signal to the terminal controller 2200.

The terminal communicator 2100 may receive an invitation message or a response signal from the terminal controller 2200 and transmit the received message or response signal to the server 3000.

The terminal controller 2200 may execute an invitation application previously stored in the terminal storage 2400, and provide an invitation interface provided by the application in the form of a screen or a sound that may be recognized by the user through the terminal user interface 2300.

The terminal controller 2200 may receive information including an appointment time, an appointment location, or a guest list through the terminal user interface 2300, and generate an invitation message according to the provided information.

The terminal controller 2200 may receive an input signal for determining whether to attend in response to the invitation signal through the terminal user interface 2300, and generate a response signal according to the provided input signal.

The terminal user interface 2300 may provide an interface for inputting an appointment time, an appointment location, or a guest list as information included in the invitation message under the control of the terminal controller 2200.

The terminal user interface 2300 may display the appointment time, appointment location, or guest list extracted from the invitation signal under the control of the terminal controller 2200, and provide an interface for receiving a response for determining whether to attend according to the displayed information.

The terminal user interface 2300 is for communication between the user terminals 2000, 2001, 2002, and 2003 and the user, and may receive an input signal of the user, transmit the received input signal to the terminal controller 2200, and provide information held by the user terminal 2000, 2001, 2002, and 2003 to the user under the control of the terminal controller 2200. The terminal user interface 2300 may include an input module, an internal camera, a biometric sensing module, and an output module but is not limited thereto.

The terminal storage 2400 may store an invitation application activated by the control of the terminal controller 2200.

The terminal storage 2400 may be various storage devices such as a ROM, a RAM, an EPROM, a flash drive, a hard drive, and the like, as hardware. The terminal storage 2400 may store a program for the processing or controlling of the terminal controller 2200 and various data for the entire operation of the user terminal 2000, in particular, user tendency information. At this time, the terminal storage 2400 may be integrally formed with the terminal controller 2200 or may be implemented as a lower component of the terminal controller 2200.

FIG. 4 is a block diagram illustrating an invitation device using an autonomous vehicle installed at a server side according to an embodiment of present disclosure.

Referring to FIG. 4, an invitation device using an autonomous vehicle may include a server communicator 3100, a server controller 3200, a server user interface 3300, and a server storage 3400.

The server 3000 to which the invitation device using the autonomous vehicle is applied may include other components in addition to the components shown in FIG. 4 and described below, or may not include some of the components shown in FIG. 4 and described below.

The server communicator 3100 may receive an invitation message including the same first meeting time applied to each of at least two vehicles 1000, 1001, 1002, and 1003 from the host user terminal 2000.

The server communicator 3100 may transmit an invitation signal generated by the server controller 3200 to each of at least two user terminals 2001, 2002, and 2003, and receive a response signal in response to the invitation signal from the at least two user terminals 2001, 2002, and 2003.

The server communicator 3100 may transmit control signals generated by the server controller 3200 to each of at least two vehicles 1000, 1001, 1002, and 1003.

The server communicator 3100 may receive driving situation information from at least two vehicles 1000, 1001, 1002, and 1003 based on an uplink grant of a 5G network connected to drive at least two vehicles 1000, 1001, 1002, and 1003 in the autonomous driving mode

The server controller 3200 may generate an invitation signal based on the first meeting time included in the invitation message provided from the server communicator 3100. Here, the first meeting time may include an appointment date and an appointment time.

The server controller 3200 may determine a first route plan for each of at least two vehicles 1000, 1001, 1002, and 1003 based on the response signal received through the server communicator 3100, and generate a control signal according to the determined first route plan. Here, the first route plan may be a plan in which at least two vehicles arrive at the first location at the first meeting time. In addition, the first location may be an appointment location inputted by the user terminal 2000 of the host.

The server controller 3200 may determine whether the first route plan is to be completed successfully, change the first route plan to a second route plan as it is determined that the first route plan is not to be completed successfully, and generate a control signal according to the modified second route plan. For example, the server controller 3200 may monitor the location of the user terminal 2000, 2001, 2002, 2003 at predetermined time intervals or immediately before a boarding time, and when the locations of the user terminals 2000, 2001, 2002, and 2003 are outside the boarding location designated by the first route plan by more than a certain range, determine that the first route plan is not to be completed successfully and change the first route plan to the second route plan. Here, the second route plan may be a plan in which among at least two user terminals 2000, 2001, 2002, and 2003, except for the host user terminal 2000, the first user terminal 2001, which first transmits the response signal, designates the second meeting time and the second location, and the remaining vehicles 1000, 1002, and 1003 except the vehicle 1001 connected to the first user terminal arrive at the second meeting time and second location.

The server controller 3200 determines whether the first route plan is to be completed successfully, change the first route plan to a third route plan as it is determined that the first route plan is not to be completed successfully, and generate a control signal according to the changed third route plan. For example, the server controller 3200 may receive all driving situation information such as location information, real-time traffic situation, vehicle abnormality, vehicle internal/external environment abnormality, vehicle occupant condition abnormality, loss of property, etc., while driving the vehicles 1000, 1001, 1002, and 1003 through the server communicator 1300, calculate the estimated time to arrive at the first location by synthesizing the provided driving situation information, and if the calculated estimated time is significantly different from the first meeting time, determine that the first route plan is not to be completed successfully, and change the first route plan to a third route plan. Here, the third route plan may be a plan in which at least two vehicles 1000, 1001, 1002, and 1003 arrive at the third location at the first meeting time. That is, the server controller 3200 may determines a third location where a preset first meeting time may be observed in consideration of a driving environment in the case of a meeting in which an appointment time is more important than an appointment location, and generate a signal that controls each of the vehicles 1000, 1001, 1002, and 1003 to arrive at the determined third location.

The server controller 3200 may update the driving route of the first route plan based on driving situation information provided through the server communicator 3100 connected to the vehicle 1000, 1001, 1002, and 1003 by an uplink grant of a 5G network.

The server controller 3200 may receive a signal in response to an invitation signal of two user terminals 2001, 2002 and 2003 through the server communicator 3100, extract phone number information in the received response signal, and identify each of at least two user terminals 2001, 2002, and 2003 based on the extracted phone number information.

The server controller 3200 may compare the phone number information in the response signal with a preset value before starting the vehicle to perform authentication, generates a control signal allowing the start of the vehicles 1001, 1002, and 1003 as authentication is completed, and transmit the generated control signal through the server communicator 3100.

The server user interface 3300 may provide an interface for inputting an appointment time, an appointment location, or a guest list as information included in the invitation message under the control of the server controller 3200. At this time, the server user interface 3300 may be an interface module installed at the side of the server 3000, but may be replaced with the vehicle user interface 1300 or the terminal user interface 2300.

The server user interface 3300 is for communication between the server 3000 and the user, and may receive an input signal of the user, transmit the received input signal to the server controller 3200, and provide the user with information held by the server 3000 under the control of the server controller 3200. The server user interface 3300 may include an input module, an internal camera, a biometric sensing module, and an output module but is not limited thereto.

The server storage 3400 may store invitation application and invitation application related information transmitted through the server communicator 3100 under the control of the server controller 3200.

The server storage 3400 may be various storage devices such as a ROM, a RAM, an EPROM, a flash drive, a hard drive, and the like, as hardware. The server storage 3400 may store a program for the processing or controlling of the server controller 3200 and various data for the entire operation of the server 3000, in particular, user tendency information. At this time, the server storage 3400 may be integrally formed with the server controller 3200 or may be implemented as a lower component of the server controller 3200.

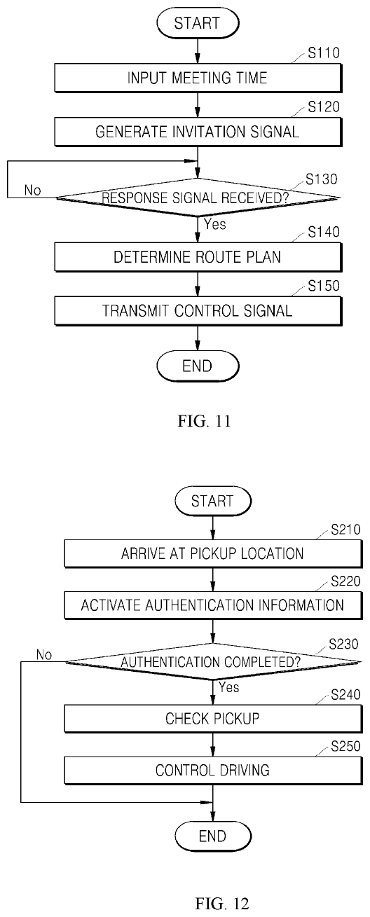

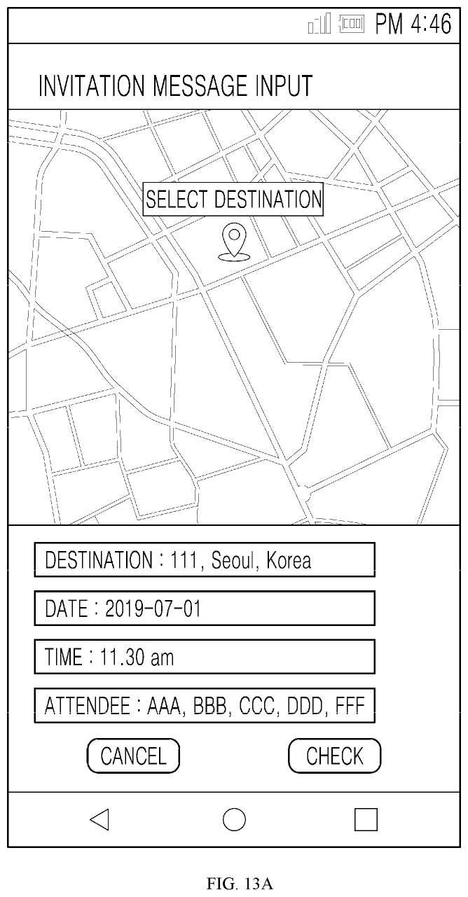

FIGS. 11 and 12 are flowcharts illustrating an invitation method using an autonomous vehicle according to an embodiment of the present disclosure.

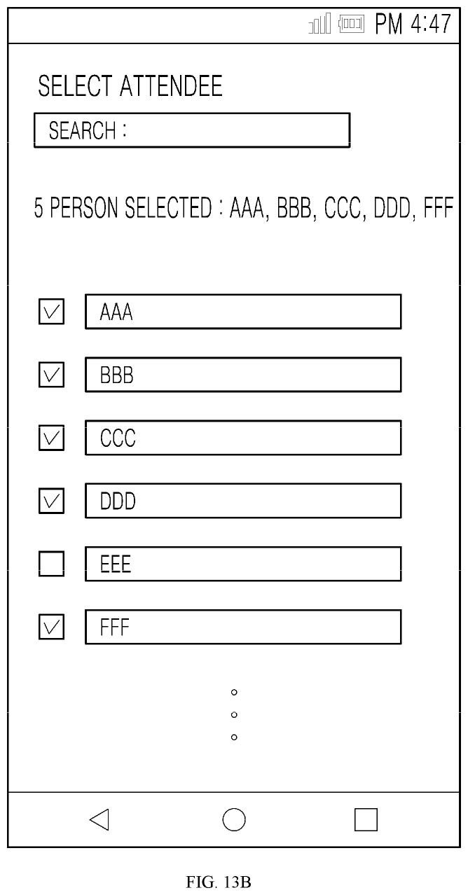

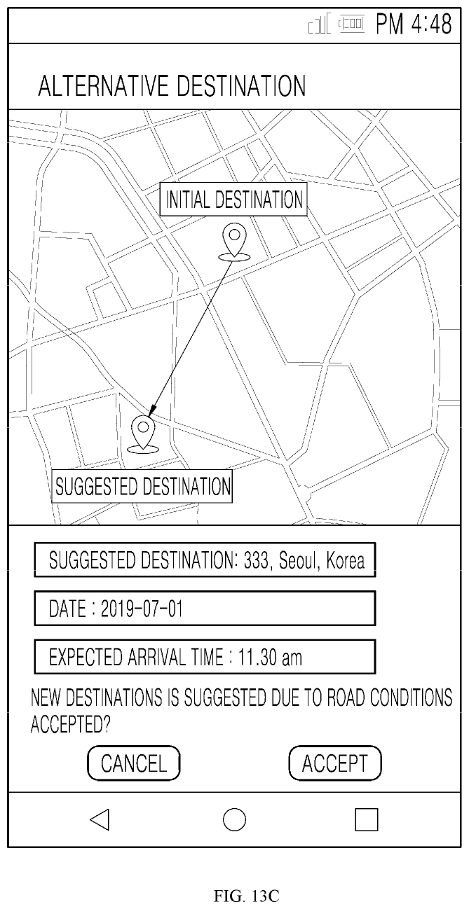

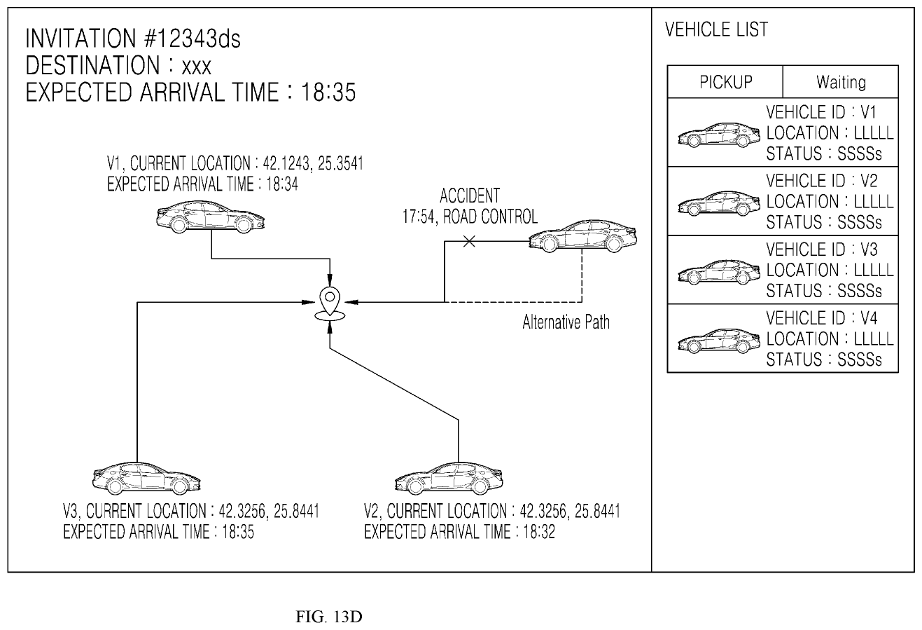

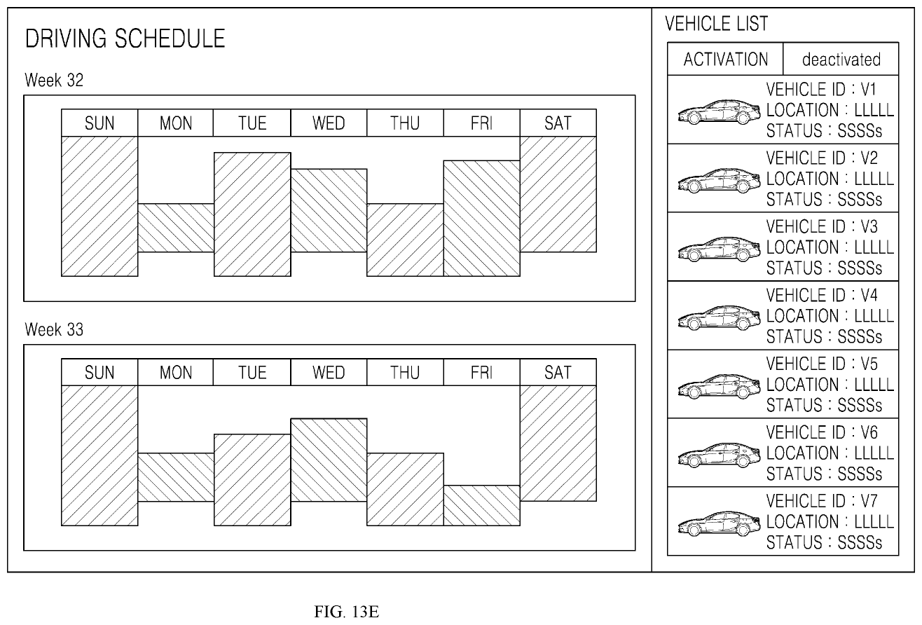

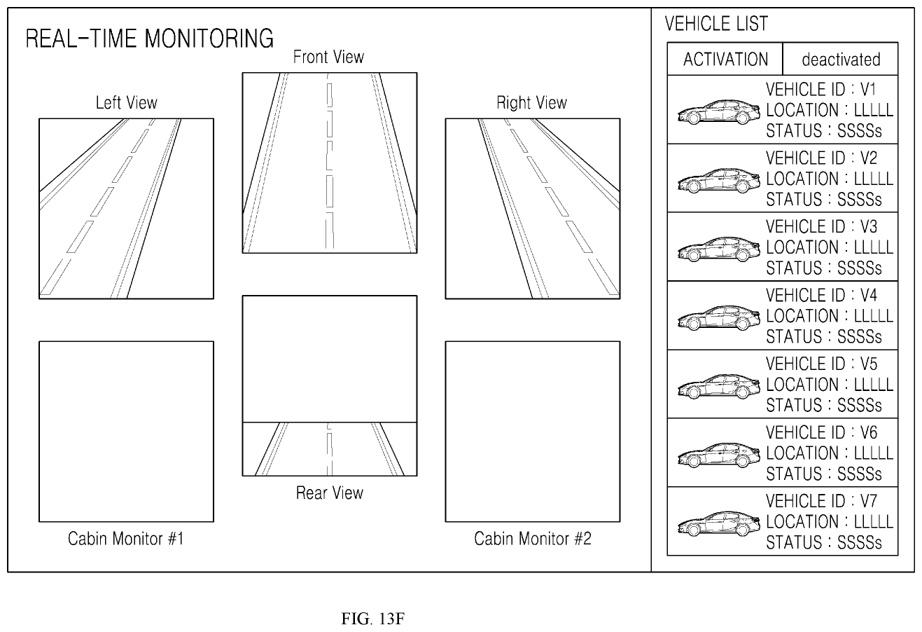

FIGS. 13A to 13F are diagrams illustrating an interface of an invitation device using an autonomous vehicle installed on a vehicle side according to an embodiment of present disclosure.

The invitation method using an autonomous vehicle may include other steps besides the steps shown in FIGS. 11 to 13F and described below, or may not include some of the steps shown in FIGS. 11 to 13F and described below.

If a user of the host user terminal 2000 wants to hold a meeting, the user who uses the host user terminal 2000 may execute a pre-downloaded invitation application, and input an appointment time, an appointment location or a guest list through the invitation interface provided by the invitation application.

For example, the user of the host user terminal 2000 may automatically input an appointment time, that is, a meeting date and a meeting time, as the first meeting time by selecting an existing meeting schedule on a calendar provided by the host user terminal 2000 or a cloud server. Meanwhile, a user of the host user terminal 2000 may directly input a meeting date and a meeting time through an invitation interface provided by the invitation application (S110).

The user of the host user terminal 2000 may allow the appointment location to be automatically inputted by selecting an existing meeting schedule on a calendar provided by the host user terminal 2000 or a cloud server. Meanwhile, a user of the host user terminal 2000 may directly input an appointment location through an invitation interface provided by the invitation application. In addition, a user of the host user terminal 2000 performs a location name search or a location search on a map through a search engine or map application provided by the host user terminal 2000, thereby inputting the appointment location.

The user of the host user terminal 2000 may select a guest who will attend a meeting and create a guest list including the specified guest. The user of the host user terminal 2000 may select the guest information from the information in the contacts previously stored in the terminal storage 2400 when creating the guest list, and in this case, automatically input the guest's phone number or email as guest information. Meanwhile, a user of the host user terminal 2000 may directly input a guest's phone number or e-mail as guest information when creating a guest list.

The terminal controller 2200 of the host user terminal 2000 may generate an invitation message with reference to the appointment time, appointment location, or guest list inputted as described above, and transmit the generated invitation message through the terminal communicator 2100. At this time, the appointment time may be a first meeting time set to allow at least two vehicles 1000, 1001, 1002, and 1003 to gather at the appointment location at the same time.

The user of the host user terminal 2000 may select one of an App Push, an MMS message, and an Email Link as a method of transmitting an invitation signal to guest user terminals 2001, 2002, and 2003.

In order to use the invitation method using an autonomous vehicle according to an embodiment of present disclosure, a service cost may be paid.

The service cost may be estimated or calculated in proportion to the traveling distance or traveling time of the autonomous vehicle, and all costs may be paid by the side of the host user terminal 2000, and the cost may be paid by each of the guest user terminals 2001, 2002, and 2003.

The server controller 3200 may receive an invitation message including the same first meeting time for each of at least two vehicles 1000, 1001, 1002, and 1003 through the server communicator 3100.

The server controller 3200 may check the appointment time, appointment location or guest list in the received invitation message, and generate an invitation signal based on the confirmed information, in particular, the first meeting time which is the appointment time (S120).

The server 3000 may include an ITS communication module in the server communicator 3100, and the server controller 3200 may collect real-time traffic information provided by the traffic system through the ITS communication module.

The server controller 3200 may collect real-time road information, for example, construction information, accident information, and entrance change information, through the server communicator 3100.

The server controller 3200 may predict a region or time-specific traffic volume by accumulating and analyzing the collected real-time traffic information.

The server controller 3200 may collect current weather information, future weather information, and the like provided by a meteorological office server or the like through the server communicator 3100.

The server controller 3200 may calculate a time required for the traveling of the vehicles 1000, 1001, 1002, and 1003 by reflecting current weather information, future weather information, and the like in the predicted region or time-specific traffic volume.

The server controller 3200 may search for traveling routes of the vehicles 1000, 1001, 1002, and 1003 using map data stored in the server storage 3400 or map data provided through the server communicator 3100.

The server controller 3200 may periodically receive location information of all the autonomous driving vehicles 1000, 1001, 1002, and 1003 registered through the server communicator 3100.

The server controller 3200 may receive vehicle unique identifier, latitude, longitude, and time information through a cellular network connected to the server communicator 3100 as location information of the autonomous driving vehicles 1000, 1001, 1002, and 1003. The server controller 3200 may read the vehicles 1000, 1001, 1002, and 1003 using the vehicle unique identifier, and store the received current location of the vehicle in the server storage 3400.

If location information of the vehicles 1000, 1001, 1002, and 1003 is needed to provide the location information inquiry function of a specific vehicle, the server controller 3200 may generate a control signal for requesting location information and transmit the generated control signal through the server communicator 3100. Subsequently, a vehicle that receives a control signal for requesting location information among the plurality of vehicles 1000, 1001, 1002, and 1003 may transmit current location information to the server 3000.

The server controller 3200 may determine whether each vehicle is out of a predetermined driving range by using location information of the vehicles 1000, 1001, 1002, and 1003 and when the vehicle is out of a predetermined driving range, the server controller 3200 may generate a control signal to return to the driving range.

The server controller 3200 may receive status information of the plurality of vehicles 1000, 1001, 1002, and 1003 through the server communicator 3100. The status information of the plurality of vehicles 1000, 1001, 1002, and 1003 received through the server communicator 3100 may include a vehicle speed, a fuel remaining amount, and whether the vehicle device is abnormal. If it is determined that there is an abnormal state using the received status information, the server controller 3200 may generate a control signal for performing an operation such as notification, autonomous driving mode release, remote control, and the like.

In order to receive status information of a plurality of vehicles 1000, 1001, 1002, and 1003, the server communicator 3100 may support communication protocols such as Data Distribute Service (DDS), Diagnostic over IP (DoIP), and Scalable Service-Oriented MiddlewarE over IP (SOME/IP).

In order to determine whether the user is boarding, the number of passengers, the user's health condition, and whether or not lost items occur in relation to a plurality of vehicles 1000, 1001, 1002, and 1003, the server controller 3200 may receive internal information of the plurality of vehicles 1000, 1001, 1002, and 1003 through the server communicator 3100.

The server controller 3200 may activate a vehicle driving schedule stored in the server storage 3400 and update a pre-scheduled regular or irregular driving schedule by reflecting status information or internal information of the vehicles 1000, 1001, 1002, and 1003. For example, when an error occurs in the first vehicle 1000, the server controller 3200 may assign the second vehicle 1001 to comply with the driving schedule of the first vehicle 1000.

The server controller 3200 may determine a vehicle driving schedule in consideration of the state information, driving range, traveling time, and the like of the vehicles 1000, 1001, 1002, and 1003.

The server controller 3200 may transmit the generated invitation signal to each of at least two user terminals 2001, 2002, and 2003 through the server communicator 3100.

The server controller 3200 may check the guest list in the invitation message and transmit an invitation signal to the guest user terminals 2001, 2002, and 2003 based on the list.

The server controller 3200 may receive a response signal in response to the invitation signal from each of at least two user terminals 2001, 2002, and 2003 through the server communicator 3100 (S130).

When an invitation signal is received through the terminal communicator 2100, the terminal controller 2200 may check a meeting location and a schedule through the terminal user interface 2300 and provide an interface for inputting a signal for determining whether to attend. That is, if not attending a meeting, a user who is a guest may input a non-attendance signal, and if attending a meeting, the user may request the boarding of the vehicle immediately or the registration for a future schedule, depending on the starting point of the meeting.

If it is determined that the user will attend the meeting based on the result of analyzing the signal input through the terminal user interface 2300, the terminal controller 2200 may control the user to select a boarding position through the terminal user interface 2300.

As a method for selecting a boarding position through the terminal user interface 2300, there are an immediate boarding method in which a vehicle departs directly to the current location of a user, a future schedule-based selection method for selecting a boarding position based on a user's future schedule, a behavior pattern based selection method for predicting and suggesting a boarding position depending on a learned model according to user's behavior pattern, and a random selection method in which a user arbitrarily selects a boarding position. Here, the behavior pattern-based selection method may be a method of selecting a position where the user may easily board at a predetermined boarding time using a machine-learned model according to the behavior patterns of users (commute to work, commute to school, etc.) who fulfill the predetermined schedule.

Artificial intelligence (AI) is an area of computer engineering science and information technology that studies methods to make computers mimic intelligent human behaviors such as reasoning, learning, self-improving, and the like.

Also, AI does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

More specifically, machine learning is a technology that investigates and builds systems, and algorithms for such systems, that are capable of learning, making predictions, and enhancing its own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a previous layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron may be activated and output an output value obtained through an activation function.

A deep neural network with a plurality of hidden layers between the input layer and the output layer may be the most representative type of artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

The server controller 3200 may analyze the received response signal and select the guest who refuses to attend the meeting or the guest who exceeds the response deadline for the invitation, and treat the selected guest as a non-attendee.

The server controller 3200 may determine a first route plan for each of at least two vehicles based on the response signal, and generate a control signal according to the determined first route plan (S140).

The server controller 3200 may allocate a vehicle to be controlled by the first route plan to the host and the guest.

First, the server controller 3200 may determine a list of vehicles which have no driving schedule based on the boarding location and time selected by a host and a guest through the user terminals 2000, 2001, 2002, and 2003. Here, whether a predetermined vehicle is available based on the boarding location and time selected by the host and the guest through the user terminals 2000, 2001, 2002, and 2003 may be determined based on whether the selected boarding position is within the driving range of the vehicle and whether the selected boarding time is empty in the driving schedule of the vehicle.

The server controller 3200 provides a list of available vehicles to the user terminals 2000, 2001, 2002, and 2003 of the host and guest together with the model, size, option, and cost related information on the corresponding vehicle through the server communicator 3100.

The host and the guest may receive a list of available vehicles and the model, size, option, and cost related information on the corresponding vehicle through the user terminals 2000, 2001, 2002, and 2003 and select a desired vehicle based on the received information. The vehicle selected through the user terminals 2000, 2001, 2002, and 2003 is notified to the server 3000, and the server controller 3200 may allocate an optimal vehicle to a user who owns each of the user terminals 2000, 2001, 2002, and 2003 with reference to the selected vehicle.

The server controller 3200 may notify the user who owns each of the user terminals 2000, 2001, 2002 and 2003 of the vehicle assignment result through the server communicator 3100.

The server controller 3200 may transmit a control signal generated according to the first route plan to each of at least two vehicles 1000, 1001, 1002, and 1003 through the server communicator 3100 (S150). Here, the first route plan may be a plan in which at least two vehicles 1000, 1001, 1002, and 1003 arrive at the first location at the first meeting time.

The server controller 3200 may determine whether or not the meeting may proceed successfully according to the first route plan. In order to determine whether the meeting is successful, the server controller 3200 may monitor the location of each of the user terminals 2000, 2001, 2002, and 2003 before boarding the vehicle.

The server controller 3200 may transmit a message corresponding to a result of monitoring the location of each of the user terminals 2000, 2001, 2002, and 2003 to each of the user terminals 2000, 2001, 2002, and 2003 through the server communicator 3100.

For example, when each of the user terminals 2000, 2001, 2002, and 2003 is out of a predetermined range from a predetermined boarding position, the server controller 3200 may transmit a location breakaway message through the server communicator 3100.

In addition, when each of the user terminals 2000, 2001, 2002, and 2003 is within a predetermined range at a predetermined boarding position, the server controller 3200 may transmit a boarding remind message through the server communicator 3100.

The server controller 3200 may receive a boarding position change request signal of each of the user terminals 2000, 2001, 2002, and 2003 through the server communicator 3100, and reallocate the vehicles 1000, 1001, 1002, and 1003 to a changed position according to the inputted signal.

The server controller 3200 may generate a control signal for allowing the autonomous driving vehicles 1000, 1001, 1002, and 1003 to perform a boarding procedure based on the boarding location and appointment time of each of the user terminals 2000, 2001, 2002, and 2003, and transmit the generated control signal through the server communicator 3100.

In order to generate a control signal for performing a boarding procedure of the autonomous driving vehicles 1000, 1001, 1002, and 1003, the server controller 3200 may refer to a guest's boarding location, appointment location, appointment time, real-time or predicted traffic volume, road information, and weather information.

In order to generate a control signal for performing a boarding procedure of the autonomous driving vehicles 1000, 1001, 1002, and 1003 during the autonomous driving, the server controller 3200 may search for an optimal route from the current location of the vehicle to the boarding location and an optimal route from the boarding location to the appointment location based on the above-mentioned reference information.

The vehicles 1000, 1001, 1002, and 1003 may arrive at a pick up location by controlling according to a control signal generated by the server controller 3200 (S210).

Upon arrival at the pickup location, the vehicles 1000, 1001, 1002, and 1003 may notify the server 3000 and the user terminals 2000, 2001, 2002, and 2003 of the arrival.

The user terminals 2000, 2001, 2002, and 2003 notified by the vehicles 1000, 1001, 1002, and 1003 perform an authentication procedure for checking whether a host is invited and a guest is invited by activating an application for authentication (S220).

If the authentication is completed successfully (S230), the owners of the user terminals 2000, 2001, 2002, and 2003 will board the vehicles 1000, 1001, 1002, and 1003 assigned to the respective owners, and check whether the boarding is completed.

If the authentication is failed, the owners of the user terminals 2000, 2001, 2002, and 2003 cannot board the vehicles 1000, 1001, 1002, and 1003 assigned to the respective owners, and even if the owners board the vehicles, the vehicles 1000, 1001, 1002, and 1003 may not be driven.

When the boarding is completed, the server 3000 controls the driving of the vehicles 1000, 1001, 1002, and 1003 so that the owners of the user terminals 2000, 2001, 2002, and 2003 may be moved to the appointment location at the appointment time (S250).

FIG. 13A illustrates an example of an interface for inputting invitation information through the terminal user interface 2300 in relation to the host user terminal 2000. FIG. 13B illustrates an example of an interface for selecting a guest through the terminal user interface 2300 in relation to the host user terminal 2000.

FIG. 13C illustrates an example of an interface for receiving a suggestion of a new time and location, for example, a second meeting time and a second location, through the terminal user interfaces 2300 of the user terminals 2000, 2001, 2002, and 2003 if the server 3000 determines that the first route plan cannot be completed successfully because, for some reason, all hosts and guests, or some guests cannot arrive at the appointment location at the appointment time.

In particular, the server 3000 may provide a function of suggesting a location, for example, a third location, where all hosts and guests may meet without changing the appointment time through an invitation application activated in the user terminals 2000, 2001, 2002, and 2003.

If all the user terminals 2000, 2001, 2002, and 2003 accept the suggested third location, the routes of the vehicles 1000, 1001, 1002, and 1003 are changed to drive toward the third location.

FIGS. 13D to 13F illustrate examples of an interface for an administrator provided by the server user interface 3300, and as illustrated in FIG. 13D, the administrator may check the driving route and estimated arrival time of the vehicles 1000, 1001, 1002, and 1003 that are being autonomously driven for each invitation through the server user interface 3300.

As illustrated in FIG. 13E, the administrator may recognize and manage the driving schedules of the vehicles 1000, 1001, 1002, and 1003 through the server user interface 3300.

In addition, as shown in FIG. 13F, the administrator may check in real time the image acquired by the object detectors 1400 of the vehicles 1000, 1001, 1002, and 1003 through the server user interface 3300.

The present disclosure described above may be implemented as a computer-readable code in a medium on which a program is recorded. The computer readable medium includes all types of recording devices in which data readable by a computer system readable may be stored. Examples of the computer readable medium include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and it may also be implemented in the form of a carrier wave (for example, transmission over the Internet). In addition, the computer may include a processor or a controller. Therefore, the above description should not be construed as limiting and should be considered illustrative. The scope of the present disclosure should be determined by rational interpretation of the appended claims, and all changes within the scope of equivalents of the present disclosure are included in the scope of the present disclosure.

What is claimed is:

1. An invitation device using an autonomous vehicle, which is applied to a vehicle management system which is connected to at least two user terminals and manages driving of at least two vehicles, the invitation device comprising:
a communicator configured to receive an invitation message including a same first meeting time applied to each of the at least two vehicles; and
a controller configured to generate an invitation signal based on the first meeting time,
wherein the communicator transmits the invitation signal generated by the controller to each of the at least two user terminals and receives a response signal which responds to the invitation signal,
wherein the controller determines a first route plan for each of the at least two vehicles based on the response signal and generates a control signal according to the determined first route plan,
wherein the communicator transmits a control signal generated by the controller to each of the at least two vehicles,
wherein the first route plan is a plan in which the at least two vehicles arrive at a first location at the first meeting time.

2. The invitation device of claim 1, wherein the controller determines whether the first route plan is to be completed successfully, changes the first route plan to a second route plan as it is determined that the first route plan is not completed successfully, and generates a control signal according to the changed second route plan,
wherein the second route plan is a plan in which a first user terminal, which transmits the response signal first among the at least two user terminals, designates a second meeting time and a second location, and the remaining vehicles except for a vehicle connected to the first user terminal arrive at the second location at the second meeting time.

3. The invitation device of claim 1, wherein the controller determines whether the first route plan is to be completed successfully, changes the first route plan to a third route plan as it is determined that the first route plan is not to be completed successfully, and generates a control signal according to the changed third route plan,
wherein the third route plan is a plan in which the at least two vehicles arrive at a third location at the first meeting time.

4. The invitation device of claim 1, wherein the communicator receives driving situation information based on an uplink grant of a 5G network which is connected in order to drive the at least two vehicles in an autonomous driving mode,
wherein the controller updates a driving route of the first route plan based on the driving situation information provided from the communicator.

5. The invitation device of claim 1, wherein the controller extracts phone number information in the response signal and identifies the at least two user terminals based on the extracted phone number information.

6. The invitation device of claim 5, wherein the controller performs authentication by comparing the phone number information with a preset value before starting the vehicle, and permits the vehicle to be started as the authentication is completed.

7. An invitation method using an autonomous vehicle, which is applied to a vehicle management system which is connected to at least two user terminals and manages driving of at least two vehicles, the method comprising:
receiving an invitation message including a same first meeting time applied to each of the at least two vehicles;
generating an invitation signal based on the first meeting time;
transmitting the invitation signal to each of the at least two user terminals and receiving a response signal which responds to the invitation signal;
determining a first route plan for each of the at least two vehicles based on the response signal and generating a control signal according to the determined first route plan; and
transmitting the generated control signal to each of the at least two vehicles,
wherein the first route plan is a plan in which the at least two vehicles arrive at a first location at the first meeting time.

8. The method of claim 7, further comprising determining whether the first route plan is to be completed successfully, changing the first route plan to a second route plan as it is determined that the first route plan is not completed successfully, and generating a control signal according to the changed second route plan,
wherein the second route plan is a plan in which a first user terminal, which transmits the response signal first among the at least two user terminals, designates a second meeting time and a second location, and the remaining vehicles except for a vehicle connected to the first user terminal arrive at the second location at the second meeting time.

9. The method of claim 7, further comprising determining whether the first route plan is to be completed successfully, changing the first route plan to a third route plan as it is determined that the first route plan is not to be completed successfully, and generating a control signal according to the changed third route plan,
wherein the third route plan is a plan in which the at least two vehicles arrive at a third location at the first meeting time.

10. The method of claim 7, further comprising receiving driving situation information based on an uplink grant of a 5G network which is connected in order to drive the at least two vehicles in an autonomous driving mode; and
updating a driving route of the first route plan based on the driving situation information.

11. The method of claim 7, further comprising extracting phone number information in the response signal and identifying the at least two user terminals based on the extracted phone number information.

12. The method of claim 11, further comprising performing authentication by comparing the phone number information with a preset value before starting the vehicle, and permitting the vehicle to be started as the authentication is completed.

13. A computer-readable recording medium recording an invitation program using an autonomous vehicle, which is applied to a vehicle management system which is connected to at least two user terminals and manages driving of at least two vehicles, the medium comprising:
a means for receiving an invitation message including a same first meeting time applied to each of the at least two vehicles;
a means for generating an invitation signal based on the first meeting time;
a means for transmitting the invitation signal to each of the at least two user terminals and receiving a response signal which responds to the invitation signal;
a means for determining a first route plan for each of the at least two vehicles based on the response signal and generating a control signal according to the determined first route plan; and
a means for transmitting the generated control signal to each of the at least two vehicles,
wherein the first route plan is a plan in which the at least two vehicles arrive at a first location at the first meeting time.
